(19) United States
(12) Patent Application Publication
(10) Pub. No.: US 2017/0207426 A1
(43) Pub. Date: Jul. 20, 2017

(54) BATTERY CELL

(71) Applicant: SK Innovation Co., Ltd., Seoul (KR)

(72) Inventors: Tae Il KIM, Daejeon (KR); Dong Ju KIM, Daejeon (KR); Jin Go KIM, Daejeon (KR); Seung Noh LEE, Daejeon (KR)

(21) Appl. No.: 15/401,626

(22) Filed: Jan. 9, 2017

(30) Foreign Application Priority Data
Jan. 15, 2016 (KR) 10-2016-0005119

(51) Int. Cl. H01M 2/02; H01M 10/04

(52) U.S. Cl. CPC H01M 2/024; H01M 10/0413; H01M 2220/20

(57) ABSTRACT

A battery cell includes a case including a side wall portion defining the depth of a receiving space and a planar portion extending from the side wall portion to complete the receiving space; and an electrode assembly formed by stacking a plurality of electrode plates, and received in the receiving space formed inside the case. The side wall portion includes a second side wall extending from the planar portion; and a first side wall extending from the second side wall. The first side wall and the second side wall have different angles of inclination with respect to the planar portion.

### CROSS-REFERENCE TO RELATED APPLICATION

This application claims the benefit of priority to Korean Patent Application No. 10-2016-0005119, filed on Jan. 15, 2016 with the Korean Intellectual Property Office, the entirety of which is incorporated herein by reference.

### BACKGROUND

The present invention relates to a battery cell that may allow for a significantly increased internal space.

Commonly, secondary cell batteries may be recharged, and may have a large capacity. Nickel-cadmium, nickel-hydride, and lithium-ion batteries are typical types of secondary cell battery. Among such typical secondary cell batteries, lithium-ion batteries are drawing attention as next-generation power sources due to possessing excellent characteristics such as a long lifespan, high capacity, and the like.

Lithium-ion secondary batteries having an operating voltage of 3.6V or higher are commonly used as power sources in mobile electronic devices, and several lithium ion batteries may be connected to each other for use in high-output hybrid vehicles. Because an operating voltage of lithium-ion secondary batteries may be three times higher than that of nickel-cadmium batteries or nickel-metal hydride batteries, and the characteristics of energy density of lithium-ion secondary batteries per unit weight are excellent, the use of lithium-ion secondary batteries is rapidly increasing.

In general, lithium-ion secondary batteries are manufactured in battery cell units, and are classified as either can-type secondary batteries having an electrode assembly embedded in a metal can or pouch-type secondary batteries having an electrode assembly embedded in a pouch of an aluminum laminate sheet, according to the shape of an exterior material.

Such lithium-ion secondary batteries are generally manufactured by injecting an electrolyte into a case while an electrode assembly is received in the case, and sealing the case.

FIG. 1 is an exploded perspective view illustrating a configuration of a pouch-type battery cell of the related art. FIG. 2 is a perspective view of the pouch-type battery cell illustrated in FIG. 1. FIG. 3 is a cross-sectional view taken along line I-I′ of FIG. 2.

Referring to FIGS. 1 through 3, the pouch-type battery cell of the related art generally includes an electrode assembly 10 and a pouch case 20 receiving the electrode assembly 10.

Here, the electrode assembly 10 is provided with an electrode plate, that is, an anode plate and a cathode plate, and a separator (not illustrated) maybe interposed between the anode and cathode plates. Each of the anode and cathode plates has at least one electrode tab 11, that is, an anode tab and a cathode tab, provided thereon.

The anode tab and the cathode tab are coupled to electrode leads 12, that is, an anode lead and a cathode lead, respectively, and portions of the anode and cathode leads are exposed externally from the pouch case 20 to function as electrode terminals so as to be electrically connected to an element provided externally of a secondary battery, for example, another secondary battery or external device.

The electrode assembly 10 is configured in a stack-type electrode assembly as illustrated in FIG. 1. Here, the stack-type electrode assembly is an electrode assembly having a plurality of anode plates and a plurality of cathode plates, and the anode and cathode plates are alternately stacked with separators interposed therebetween.

The pouch case 20 includes an upper case 21 and a lower case 22. The electrode assembly 10 and the electrolyte are received in an internal space formed by the upper case 21 and the lower case 22. The upper case 21 and the lower case 22 have sealing portions S formed along edges thereof to seal the internal space, and the sealing portions S are bonded to each other to seal the internal space.

The pouch case 20 protects internal components such as the electrode assembly 10, the electrolyte, and the like, and includes a thin aluminum film in order to complement electrochemical properties obtained using the electrode assembly 10 and the electrolyte and improve heat dissipation properties.

Such a thin aluminum film is interposed between insulating layers formed of an insulating material, in order to ensure electrical insulation properties with internal components of the secondary battery such as the electrode assembly 10 and the electrolyte and with other external components of the secondary battery.

However, because the pouch case 20 of the related art has low rigidity, the shape of the pouch case 20 collapses and is crushed when the electrolyte is injected thereinto and gas is removed from the inside of the pouch case 20, as illustrated in FIG. 3 (refer to arrows).

In this manner, when the shape of the pouch case 20 collapses, the internal space of the pouch case 20 is not maintained and instead is rather reduced, and thus, a space to be filled with the electrolyte is also reduced.

### SUMMARY

An aspect of the present disclosure may provide a battery cell that may allow for an internal space of a case by maintaining the shape of the case.

According to an aspect of the present disclosure, a battery cell includes: a case including a side wall portion defining the depth of a receiving space and a planar portion extending from the side wall portion to complete the receiving space; and an electrode assembly formed by stacking a plurality of electrode plates, and received in the receiving space formed inside the case, in which the side wall portion includes a second side wall extending from the planar portion and a first side wall extending from the second side wall, and the first side wall and the second side wall have different angles of inclination with respect to the planar portion.

An angle of inclination of the first side wall may be less than an angle of inclination of the second side wall.

The angle of inclination of the second side wall may be greater than the angle of inclination of the first side wall and equal to or less than 90°.

The second side wall may contact the electrode assembly and control movements of the electrode assembly.

According to an aspect of the present disclosure, a battery cell includes: a case including a side wall portion defining the depth of a receiving space and a planar portion extending from the side wall portion to complete the receiving space; and an electrode assembly formed by stacking a plurality of electrode plates, and received in the receiving space formed inside the case, in which the case has a bent line parallel to the outside of the planar portion, formed within the side wall portion, and dividing the side wall portion into a first side wall and a second side wall.

The case may include a first case and a second case coupled to each other, and portions of the receiving space may be formed in the first case and the second case, respectively.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is an exploded perspective view illustrating a configuration of a pouch-type battery cell of the related art;

FIG. 2 is a perspective view of the pouch-type battery cell illustrated in FIG. 1;

FIG. 3 is a cross-sectional view taken along line I-I′ of FIG. 2;

FIG. 4 is a perspective view schematically illustrating a pouch-type battery cell according to an embodiment;

FIG. 5 is a perspective view of the pouch-type battery cell illustrated in FIG. 4; and

FIG. 6 is a cross-sectional view taken along line II-II′ of FIG. 5.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no other elements or layers intervening therebetween. Like numerals refer to like elements throughout. As used herein, the term “and/or” includes any and all combinations of one or more of the associated listed items.

It will be apparent that although the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship relative to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape resulting from manufacturing. The following embodiments may also be constituted alone or as a combination thereof.

The contents of the present disclosure described below may have a variety of configurations and only a required configuration is proposed herein, but the present disclosure is not limited thereto.

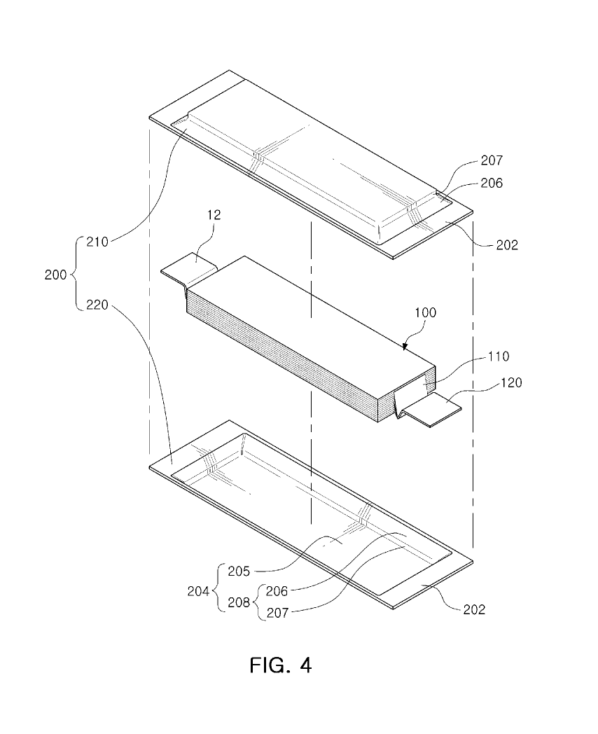

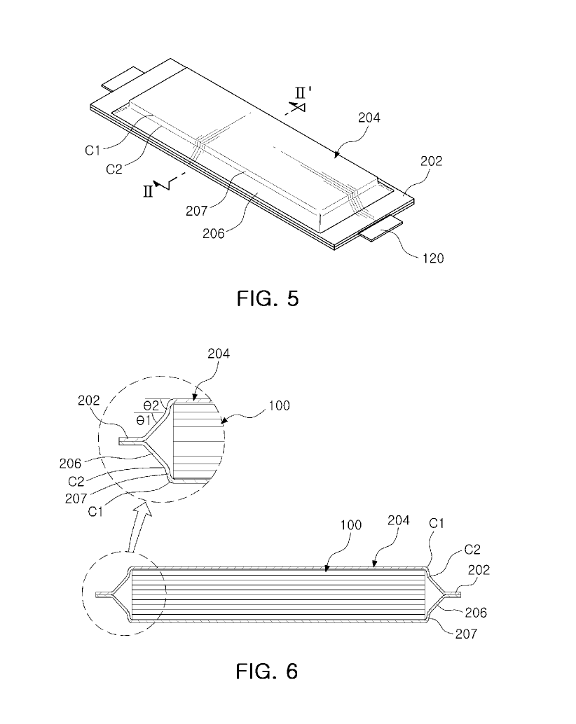

FIG. 4 is an exploded perspective view schematically illustrating a pouch-type battery cell according to an embodiment. FIG. 5 is a perspective view of the pouch-type battery cell illustrated in FIG. 4. FIG. 6 is a cross-sectional view taken along line II-II' of FIG. 5.

Referring to FIGS. 4 through 6, the pouch-type battery cell includes an electrode assembly 100 and a pouch case 200.

The electrode assembly 100 includes a plurality of electrode plates and a plurality of electrode tabs 110, and is received in receiving portions 204 of the pouch case 200. Here, the electrode plates include a plurality of anode plates and a plurality of cathode plates, and the electrode assembly 100 includes the anode and cathode plates stacked with each other such that wide surfaces thereof face each other with separators interposed therebetween.

The anode and cathode plates are formed by coating a current collector with an active material slurry, and a slurry is commonly formed by mixing a particle-phase active material, a subconductor, a binder, and a plasticizer while a solvent is added thereto.

The electrode assembly 100 also includes the anode and cathode plates stacked in a vertical direction. Here, the anode and cathode plates have the electrode tabs 110 provided thereon, respectively, and anode and cathode plates having the same polarities contact each other to be connected to common electrode leads 120, respectively.

The pouch case 200 includes a first case 210 and a second case 220. The first and second cases 210 and 220 include sealing portions 202 and receiving portions 204.

The sealing portions 202 are disposed along the outsides of the receiving portions 204.

The sealing portion 202 of the first case 210 and the sealing portion 202 of the second case 220 are bonded to each other to seal an internal space formed by the receiving portions 204.

The sealing portions 202 are bonded to each other in a thermal fusion manner, but a bonding manner of the sealing portions 202 is not limited thereto. In order to significantly reduce an area of the sealing portions 202, the sealing portions 202 may be folded at least once after being bonded to each other.

The sealing portions 202 are formed in a container shape to provide the internal space. In an embodiment, the sealing portions 202 extend from sides of the receiving portions 204 having the container shape.

The electrode assembly and an electrolyte (not illustrated) are received in the internal space of the receiving portions 204. The receiving portions 204 are formed in all of the first and second cases 210 and 220, as illustrated in FIG. 4. However, the receiving portion 204 may also only be formed in one of the first and second cases 210 and 220, as desired.

In addition, the receiving portions 204 according to this embodiment include planar portions 205 and side wall portions 208.

The planar portions 205 are one surfaces of the receiving portions 204 formed to have a wide area, and form a bottom surface or an upper surface of the internal space of the receiving portions 204. Thus, the planar portions 205 extend from the side wall portions 208 to complete the internal space.

Also, the planar portions 205 are formed to have a size corresponding to an area of the electrode assembly 100, and are substantially parallel to the sealing portions 202.

The side wall portions 208 connect the receiving portions 204 to the planar portions 205. The side wall portions 208 extend from the sealing portions 202 to connect to the outsides of the planar portions 205, and define the depth of the internal space of the receiving portions 204.

Each of the side wall portions 208 includes a plurality of side walls 206 and 207 having different angles of inclination. In this embodiment, the side wall portion 208 includes a first side wall 206 and a second side wall 207.

Referring to FIGS. 5 and 6, the first side wall 206 extends from the sealing portion 202 and an angle of inclination between the first side wall 206 and the sealing portion 202 or the planar portion 205 is defined by θ1. In addition, the second side wall 207 is disposed between the first side wall 206 and the planar portion 205, and an angle of inclination between the second side wall 207 and the sealing portion 202 or the planar portion 205 is defined by θ2.

The angle of inclination θ1 of the first side wall 206 is less than the angle of inclination θ2 of the second side wall 207. In this embodiment, the angle of inclination θ1 of the first side wall 206 is 41°, the angle of inclination θ2 of the second side wall 207 is 71°, but the angles of inclination of the first and second side walls 206 and 207 are not limited thereto.

The side wall portion 208 includes the first and second side walls 206 and 207, and thus at least one second bent line C2 differentiating the first and second side walls 206 and 207 is provided in the side wall portion 208.

Accordingly, the first side wall 206 is defined as a portion of the side wall portion 208 disposed between the sealing portion 202 and the second bent line C2, and the second side wall 207 is defined as a portion of the side wall portion 208 disposed between the second bent line C2 and the planar portion 205.

In the pouch-type battery cell according to this embodiment configured as described above, the exterior of the pouch case 200 may not be easily modified by the first and second side walls 206 and 207 included in the side wall portion 208.

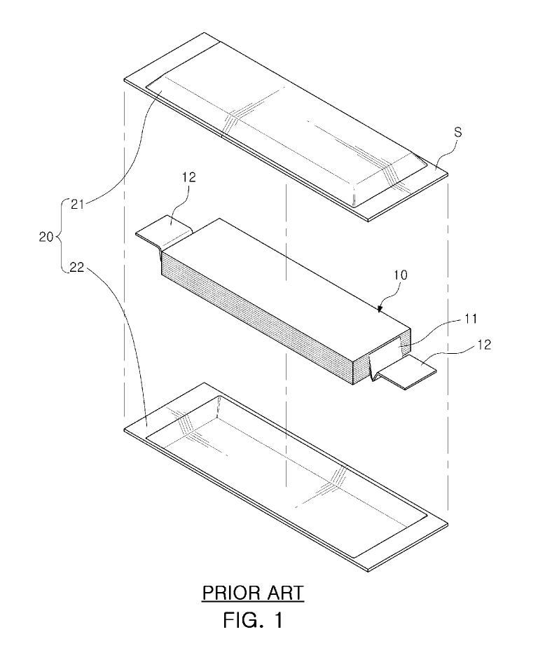

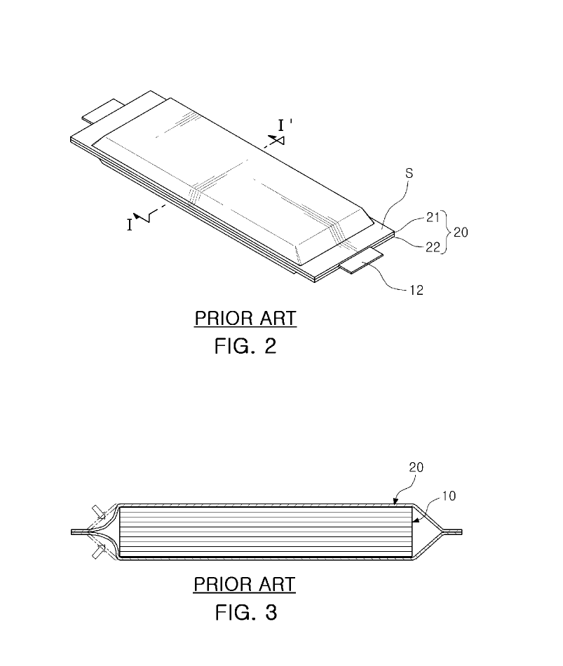

In a pouch-type battery cell of the related art, the exterior of a pouch case 20 (refer to FIG. 1) is crushed while collapsing when an electrolyte is injected into the pouch case 20 and gas is removed from the inside of the pouch case 20. When the electrolyte is injected into the pouch case 20 and the gas is removed from the inside of the pouch case 20, side walls of the pouch case 20 mainly collapse, and thus an internal space of the pouch case 20 is reduced, as illustrated in FIG. 3, resulting in a reduction in a space filled with the electrolyte.

Thus, a required amount of an electrolyte may not be injected into the internal space, or the electrolyte may flow between an electrode assembly 10 (refer to FIG. 1) and planar portions, leading to the planar portions being spaced apart from the electrode assembly 10. As a result, a battery cell having both swelled surfaces is manufactured.

However, the battery cell according to this embodiment includes first bent lines C1 each forming the outside of the planar portion 205 and each differentiating between the planar portion 205 and the second side wall 207 and the second bent lines C2 each differentiating between the first side wall 206 and the second side wall 207. The first bent lines C1 and the second bent lines C2 are spaced apart from each other to be parallel to each other, and are bent in opposite directions to each other, respectively. Thus, as compared to the battery cell according to the related art, rigidity of the battery cell maintaining the exterior of the receiving portion 204 according to an embodiment is increased.

Accordingly, even when gas is removed from the inside of the pouch case 200, the side wall portion 208 of the pouch case 200 may not easily collapse. As a result, the battery cell according to an embodiment may ensure a significantly increased internal space, thereby filling the internal space with a sufficient amount of an electrolyte and preventing both surfaces of the battery cell from swelling.

Also, the second side wall 207 may contact the electrode assembly 100 to fix the electrode assembly 100, and thus the electrode assembly 100 may be prevented from moving within the pouch case 200.

In this embodiment, only a single second bent line C2 is formed between the first and second side walls 206 and 207, but the configuration of the present disclosure is not limited thereto. For example, the present disclosure may be modified in various manners such as forming a third side wall between the first and second side walls 206 and 207 or forming a bent line therebetween, additionally.

Also, in this embodiment, the second side wall 207 is an inclined surface, but may also be a vertical surface. In an embodiment, the second angle of inclination θ2 of the second side wall 207 is 90°.

Thus, the second angle of inclination θ2 of the second side wall 207 exceeds the first angle of inclination θ1 of the first side wall 206, and may be defined as being within a range of 90° or less.

As set forth above, according to an embodiment, a battery cell may prevent a side wall portion of a case from easily collapsing even when gas is removed from the inside of the case. Thus, the battery cell may ensure a significantly increased internal space, thereby filling the internal space with a sufficient amount of an electrolyte and preventing both surfaces of the battery cell from swelling.

While exemplary embodiments have been shown and described above, it will be apparent to those skilled in the art that modifications and variations could be made without departing from the scope of the present invention as defined by the appended claims.

What is claimed is:

1. A battery cell comprising:
a case including a side wall portion defining the depth of a receiving space and a planar portion extending from the side wall portion to complete the receiving space; and
an electrode assembly formed by stacking a plurality of electrode plates and received in the receiving space formed inside the case,
wherein the side wall portion includes a second side wall extending from the planar portion and a first side wall extending from the second side wall, and the first side wall and the second side wall have different angles of inclination with respect to the planar portion.

2. The battery cell of claim 1, wherein an angle of inclination of the first side wall is less than an angle of inclination of the second side wall.

3. The battery cell of claim 1, wherein the angle of inclination of the second side wall is greater than the angle of inclination of the first side wall and equal to or less than 90°.

4. The battery cell of claim 1, wherein the second side wall contacts the electrode assembly and controls movements of the electrode assembly.

5. A battery cell comprising:
a case including a side wall portion defining the depth of a receiving space and a planar portion extending from the side wall portion to complete the receiving space; and
an electrode assembly formed by stacking a plurality of electrode plates, and received in the receiving space formed inside the case,
wherein the case has a bent line parallel to the outside of the planar portion, formed within the side wall portion, and dividing the side wall portion into a first side wall and a second side wall.

6. The battery cell of claim 5, wherein the case includes a first case and a second case coupled to each other, and portions of the receiving space are formed in the first case and the second case, respectively.
